(19) United States
(12) Patent Application Publication
(10) Pub. No.: US 2015/0267777 A1
(43) Pub. Date: Sep. 24, 2015

(54) BIAXIAL ROTATION TYPE REDUCER

(71) Applicant: Joong Ho SHIN, Changwon-si Gyeongsangnam-do (KR)

(72) Inventors: Joong Ho Shin, Changwon-si (KR); Hyun Dai Yang, Gimhae-si (KR); Ok Rye Kang, Changwon-si (KR); Myeong Jin Shin, Changwon-si (KR); Myeong Cheol Shin, Changwon-si (KR)

(21) Appl. No.: 14/429,850

(22) PCT Filed: Sep. 16, 2013
(86) PCT No.: PCT/KR2013/008357

§ 371 Date: May 18, 2015

(30) Foreign Application Priority Data
Sep. 20, 2012 (KR) 10-2012-0104293

(51) Int. Cl. F16H 1/46

(52) U.S. Cl. CPC F16H 1/46

(57) ABSTRACT

The present invention relates to a biaxial rotation type reducer in which a driving force transferred to one input shaft is outputted to two output shafts and the two output shafts are rotated in opposing directions to each other. Because the driving force transferred to one input shaft is outputted to the two output shafts and the two output shafts are rotated in opposing directions to each other, the biaxial rotation type reducer can make a progress direction of a ship or a boat constant if the biaxial rotation type reducer is used in the ship, the boat or a submarine which generates propulsion by rotating a propeller using a driving force of a motor. If the biaxial rotation type reducer is used in a mixer, because the two blades are rotated in the opposing directions to each other, it can improve grinding speed when the mixer grinds food.

### TECHNICAL FIELD

The present invention relates to a biaxial rotation type reducer in which a driving force transferred to one input shaft is outputted to two output shafts and the two output shafts are rotated in opposing directions to each other.

### BACKGROUND ART

In general, a reducer is a device to reduce a rotating speed when a driving force is transferred from an output shaft formed on a motor to another shaft, and mostly carries out reduction of speed using a gear.

A reducer using planet gears, out of the reducers using gears, generally uses planet gears set as shown in FIG. 8 to control a reduction gear ratio. The planet gear set shown in FIG. 8 includes a sun gear, a ring gear and a plurality of planet gears supported by a carrier which rotates on the same shaft as the sun gear and the ring gear, and obtains several speed change combinations by fixing or operating some of the sun gear, the ring gear and the carrier.

As a conventional reducer using the planet gears, FIG. 9 illustrates a planet gear reducer disclosed in Korean Utility Model Registration No. 20-0310243.

The planet gear reducer illustrated in FIG. 9 in which rotation of an input shaft is reduced by a train of planet gears and is outputted to an output shaft includes a sun input shaft having an input gear B which is small in number of teeth and is mounted at the input shaft and an input gear A which is large in number of teeth and is geared with the input gear B, such that rotation with increased speed is transferred to the train of planet gears of the planet gear reducer. Such a reducer transfers rotation power of a motor, which is transferred to the sun input shaft, to the output shaft through an output shaft internal gear (ring gear) by a driving power external gear (planet gear) after passing through the input gear A and the input gear B.

The planet gear reducer always has a fixed deceleration ratio and has one input shaft and one output shaft.

As another conventional reducer using the planet gears, FIG. 10 illustrates a reducer shown in a catalog of BARUFFALDI Company in Italy.

The reducer illustrated in FIG. 10 transfers a driving force of a motor to a pinion shaft, namely, a driving shaft, and then, outputs the driving force at a one-to-one ratio with an output shaft as it is or at a deceleration ratio of 1:N.

First, FIG. 10 shows the one-to-one deceleration ratio. In FIG. 10, when the driving force of the motor (M) is transferred to the pinion shaft, the driving force is transferred to a sun gear fixed and joined to the pinion shaft, and then, is transferred to planet gears geared with the sun gear. After that, when a carrier is rotated by the planet gears, the output shaft is rotated by the carrier so as to achieve deceleration.

Such a conventional reducer controls the deceleration ratio into the first stage or multiple stages. Because there is one output shaft if there is one input shaft, it is impossible to use the reducer if it is necessary to output in multiple axes.

In the meantime, in a case of a boat, if a propeller rotates just in one direction, the boat is sometimes deviated from a target direction.

Moreover, in a case of a mixer, a blade rotated by a conventional motor is slow in grinding speed when grinding relatively hard food because the blade is rotated just in one direction.

Furthermore, in a case of a water purifying apparatus, namely, an apparatus for purifying water by circulating water through rotation of a propeller, the water purifying apparatus is deteriorated in purification efficiency if water is circulated just in one direction.

### DISCLOSURE

### Technical Problem

Accordingly, the present invention has been made in an effort to solve the above-mentioned problems occurring in the prior arts, and it is an object of the present invention to provide a biaxial rotation type reducer which receives a driving force through one input shaft but outputs the driving force to two output shafts.

It is another object of the present invention to provide a biaxial rotation type reducer in which the two output shafts are rotated in opposing directions to each other.

It is a further object of the present invention to provide a biaxial rotation type reducer which can be used in ships, boats, mixers and water purifying apparatuses because the two output shafts are rotated in opposing directions to each other.

### Technical Solution

To achieve the above objects, the present invention provides a biaxial rotation type reducer including: a sun gear to which a driving force of a driving shaft is inputted; a first planet gear which is formed on one side of the sun gear; an idle gear which is formed on one side of the first planet gear; a first ring gear which is formed on the outside of the idle gear and geared with the idle gear; an input carrier, a center carrier and an output carrier which are rotated together by rotation of the first planet gear; a first output shaft which is fixed and combined to the output carrier; a second planet gear which is formed on one side of the first planet gear and in which interference of rotation is minimized by a bearing; a second ring gear which is formed on the outside of the second planet gear and geared with the second planet gear; and a second output shaft which is fixed and combined with the second ring gear.

### Advantageous Effects

As described above, because the driving force transferred to one input shaft is outputted to the two output shafts and the two output shafts are rotated in opposing directions to each other, the biaxial rotation type reducer can make a progress direction of a ship or a boat constant in a case that the biaxial rotation type reducer is used in the ship, the boat or a submarine which generates propulsion by rotating a propeller using a driving force of a motor.

Additionally, in a case that the biaxial rotation type reducer is used in a mixer, because the two blades are rotated in the opposing directions to each other, it can improve grinding speed when the mixer grinds food. Also, in a case that the biaxial rotation type reducer is used in a water purifying apparatus which purifies water by circulating water through rotation of a propeller, it can simultaneously rotate two propellers using one motor without circulating water just in one direction so as to activate mixing of water, thereby enhancing purification efficiency.

### DESCRIPTION OF DRAWINGS

FIG. 1 is a configurative view of a biaxial rotation type reducer according to an embodiment of the present invention.

FIG. 2 is a sectional view of the biaxial rotation type reducer.

FIG. 3 is a partially configurative view of the biaxial rotation type reducer.

FIG. 4 is an exploded view of the biaxial rotation type reducer.

FIG. 5 is a view showing a biaxial rotation type reducer according to another preferred embodiment of the present invention.

FIG. 6 is a partially configurative view of FIG. 5.

FIG. 7 is an exploded view of FIG. 5.

FIG. 8 is a configurative view of a general planet gear.

FIGS. 9 and 10 are configurative view of a conventional planet gear reducer.

### MODE FOR INVENTION

The present invention relates to a biaxial rotation type reducer in which a driving force transferred to one input shaft is outputted to two output shafts and the two output shafts are rotated in opposing directions to each other.

The biaxial rotation type reducer according to the embodiment of the present invention includes: a sun gear to which a driving force of a driving shaft is inputted; a first planet gear which is formed on one side of the sun gear; an idle gear which is formed on one side of the first planet gear; a first ring gear which is formed on the outside of the idle gear and geared with the idle gear; an input carrier, a center carrier and an output carrier which are rotated together by rotation of the first planet gear; a first output shaft which is fixed and combined to the output carrier; a second planet gear which is formed on one side of the first planet gear and in which interference of rotation is minimized by a bearing; a second ring gear which is formed on the outside of the second planet gear and geared with the second planet gear; and a second output shaft which is fixed and combined with the second ring gear.

Moreover, the input carrier, the center carrier and the output carrier are fixed and combined by a pin.

Furthermore, the output shaft 1 and the output shaft 2 receive a rotational force from the sun gear and are rotated in the opposing direction to each other.

Additionally, the first planet gear and the second planet gear are separated from each other and the second planet gear is penetrated and combined by a pin.

Hereinafter, reference will be now made in detail to the preferred embodiment of the present invention with reference to the attached drawings.

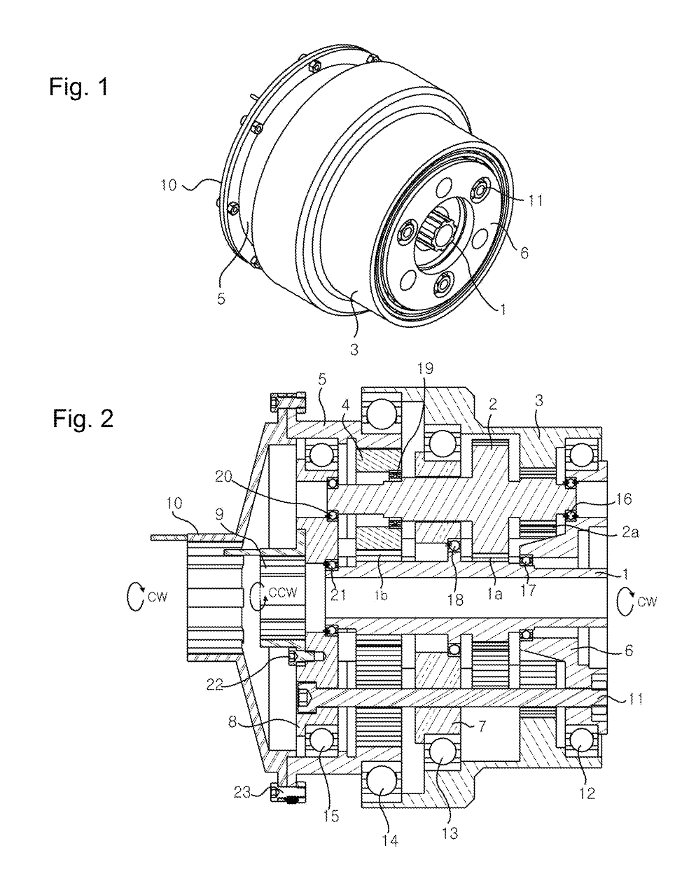

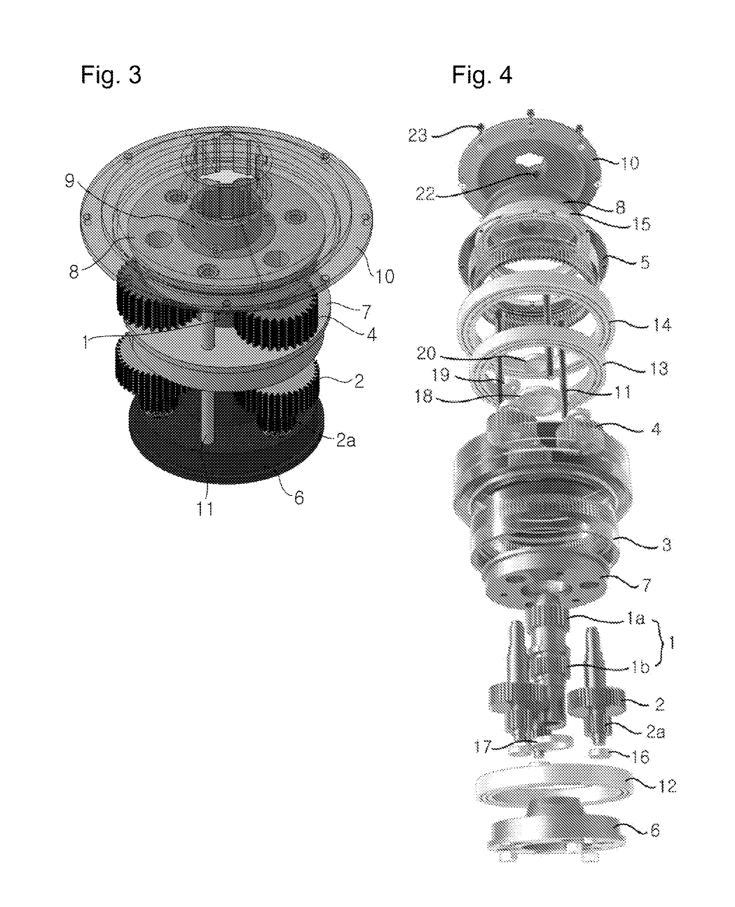

FIG. 1 is a configurative view of a biaxial rotation type reducer according to an embodiment of the present invention, FIG. 2 is a sectional view of the biaxial rotation type reducer, FIG. 3 is a partially configurative view of the biaxial rotation type reducer, and FIG. 4 is an exploded view of the biaxial rotation type reducer. The biaxial rotation type reducer according to the embodiment of the present invention includes: a sun gear 1 to which a driving force of a driving shaft is inputted; a first planet gear 2 which is formed on one side of the sun gear 1; an idle gear 2a which is formed on one side of the first planet gear 2; a first ring gear 3 which is formed on the outside of the idle gear 2a and geared with the idle gear 2a; an input carrier 6, a center carrier 7 and an output carrier 8 which are rotated together by rotation of the first planet gear 2; a first output shaft 9 which is fixed and combined to the output carrier 8; a second planet gear 4 which is formed on one side of the first planet gear 2 and in which interference of rotation is minimized by a bearing 19; a second ring gear 5 which is formed on the outside of the second planet gear 4 and geared with the second planet gear 4; and a second output shaft 10 which is fixed and combined with the second ring gear 5.

First, the sun gear 1 is a gear to which the driving force of the driving shaft is inputted, and has a spline, a gear or a key hole formed at one side thereof to be combined with the driving shaft.

The sun gear 1 has two gears formed integrally with a shaft, namely, a first gear 1a and a second gear 1b. The first gear 1a is geared with the first planet gear 2 and the second gear 1b is geared with the second planet gear 4.

The first planet gear 2 is formed on one side of the sun gear 1, and one to four first planet gears 2 may be properly formed depending on sizes or deceleration ratios of reducers.

The idle gear 2a is formed on one side of the first planet gear 2, and the idle gear 2a and the first planet gear 2 are fixed and combined to the same shaft to be rotated together, and the idle gear 2a is geared with the first ring gear 3. The center carrier 7 is formed on one side of the first planet gear 2, and the input carrier 6 and the output carrier 8 are formed and spaced apart from the center carrier 7 at a predetermined interval. The first output shaft 9 is fixed and combined to the output carrier 8, so that the driving force inputted to the sun gear 1 is finally outputted to the first output shaft 9.

The second planet gear 4 is formed on one side of the first planet gear 2, and is minimized in interference of rotation by a bearing joined to a shaft of the first planet gear 2.

The second ring gear 5 is formed on the outside of the second planet gear 4 and geared with the second planet gear 4, and the second ring gear 5 is minimized in interference of rotation by bearings 14 and 15, and the second output shaft 10 is fixed and combined to the second ring gear 5.

Hereinafter, a driving force transfer system to transfer the rotational driving force, which is inputted to the sun gear 1, to the first output shaft 9 and the second output shaft 10 will be described as follows.

First, the rotational driving force of the input shaft inputted to the sun gear 1 is transferred to the first gear 1a and the second gear 1b formed integrally with the sun gear 1. The driving force transferred to the first gear 1a is transferred to the first planet gear 2, and the driving force transferred to the first planet gear 2 is transferred to the idle gear 2a. In this instance, because the idle gear 2a is geared with the first ring gear 3 which is fixed not to be rotated, the idle gear 2a idles along the inner circumferential surface of the first ring gear 3 and the first planet gear 2 also idles. The center carrier 7 and the output carrier 8 which are penetrated by the first planet gear 2 are also idled around the sun gear 1.

The output carrier 8 is fixed and combined to the first output shaft 9 by a fixing bolt 22, and hence, the first output shaft 9 rotates around the sun gear 1.

Next, the process that the driving force is transferred to the second output shaft 2 will be described. The driving force inputted to the sun gear 1 is transferred to the second gear 1b formed integrally with the sun gear 1. Because the second gear 1b is geared with the second planet gear 4 and the second planet gear 4 is geared with the second ring gear 5, the driving force transferred to the second gear 1b is transferred to the second planet gear 4 and the second ring gear 5, and then, the second output shaft 10 is rotated because the second ring gear 5 is fixed and combined with the second output shaft 10.

In this embodiment, the three carriers, namely, the output carrier 8, the center carrier 7 and the input carrier 6, are formed, but according to circumstances, the reducer can be operated without the center carrier 7 or the input carrier 6. That is, if the first planet gear 2 and the second planet gear 4 are not moved in the axial direction of the planet gear, the reducer can be operated without the center carrier 7 or the input carrier 6.

Moreover, in the embodiment, the first planet gear 2 and the idle gear 2a are formed separately, but, if the first planet gear 2 is geared with the first ring gear 3, the idle gear 2a is not needed.

In this embodiment, the pin 11 does not penetrate the planet gear but is formed in a space between the gears to enhance stability in rotation of the carriers.

Next, the rotating direction of the first output shaft 9 and the second output shaft 10 will be described. When the sun gear 1 is rotated in the clockwise direction, the planet gear and the output carrier 8 are rotated in the counter clockwise direction, and hence, the first output shaft 9 is also rotated in the counter clockwise direction.

In this instance, because the second planet gear 4 is rotated in the counter clockwise direction but the second ring gear 5 rotates in the clockwise direction, the second output shaft 10 is rotated in the clockwise direction.

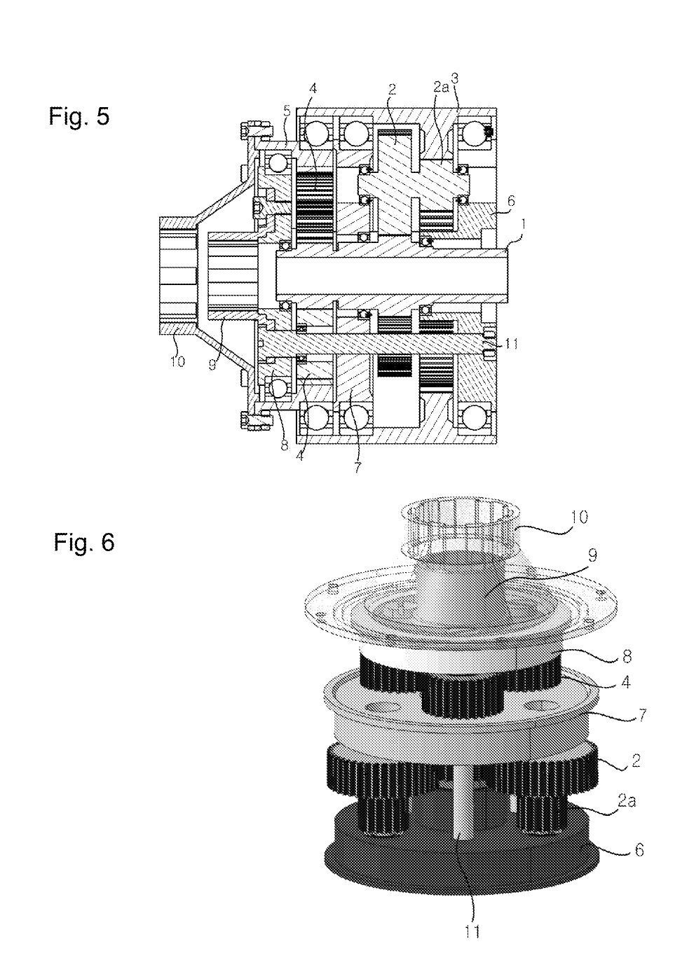

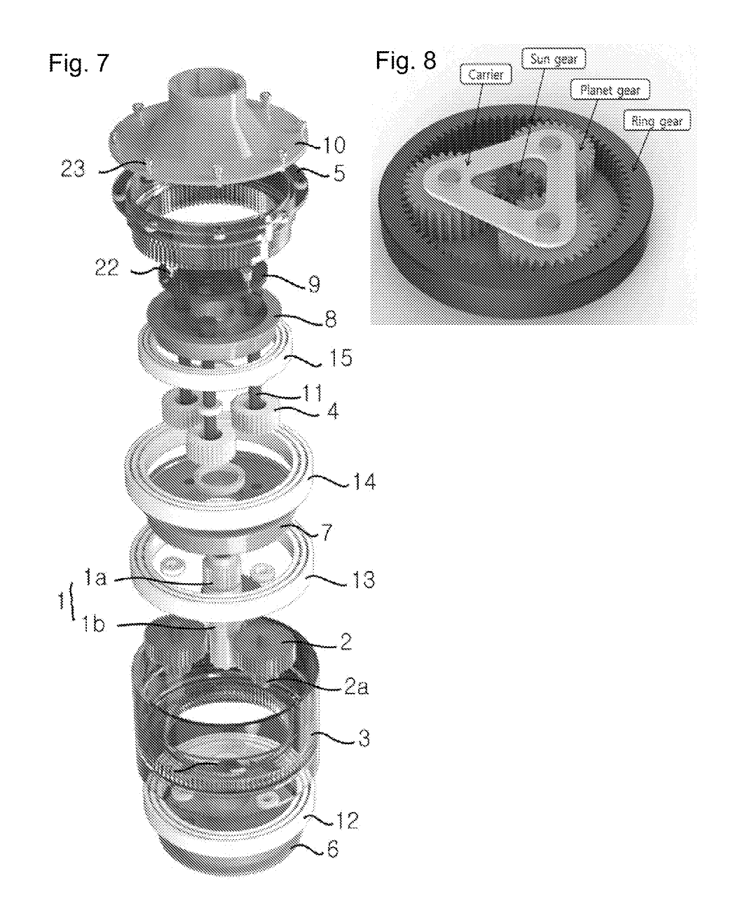

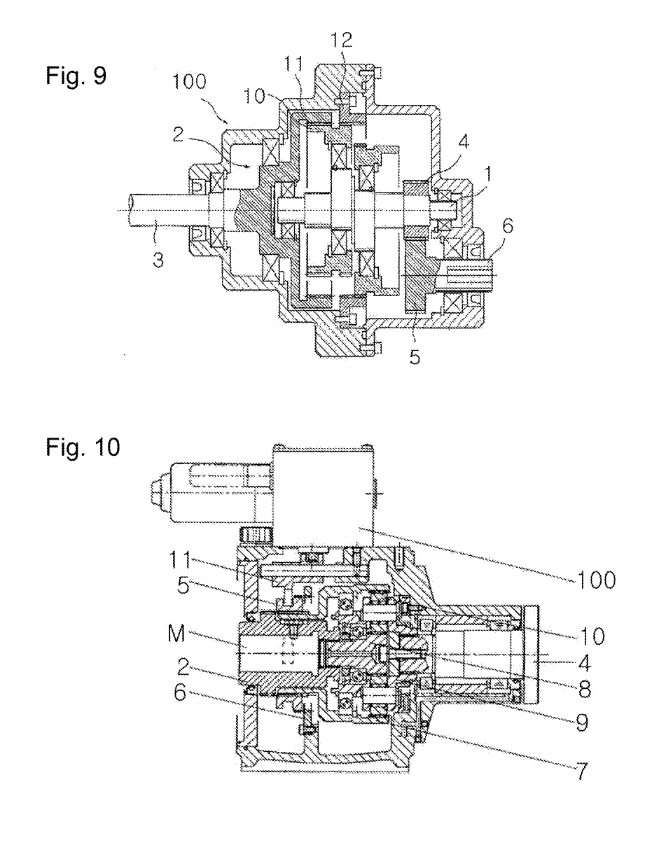

FIG. 5 is a view showing a biaxial rotation type reducer according to another preferred embodiment of the present invention, FIG. 6 is a partially configurative view of FIG. 5, and FIG. 7 is an exploded view of FIG. 5. In the drawings, the second planet gear 4 is not combined to the first planet gear 2 by a bearing but is penetrated by the pin 11 and combined to the first planet gear 2.

In this embodiment, the driving force transferred to the sun gear 1 is transferred to the first planet gear 2 and the idle gear 2a, and the first planet gear 2 and the idle gear 2a idle around the sun gear 1 because the idle gear 2a is geared with the first ring gear 3. Therefore, the center carrier 7 to which the first planet gear 2 is combined is rotated, and the input carrier 6 and the output carrier 8 which are combined with the center carrier 7 by the pin 11 are also rotated, and finally, the first output shaft 9 fixed and combined with the output carrier 8 is rotated.

Furthermore, the driving force transferred to the sun gear 1 rotates the second planet gear 4 geared with the second gear 1b. The driving force of the sun gear 1 is transferred to the second ring gear 5 because the second planet gear 4 is penetrated and combined by the pin 11 and geared with the second ring gear 5. Additionally, because the second ring gear 5 is fixed and combined with the second output shaft 10, the second output shaft 10 is rotated.

In the above-mentioned embodiments, the first planet gear 2 and the idle gear 2a are formed integrally, but, as occasion demands, it is natural that the first planet gear 2 is formed in a fashion that gears are fixed and combined to a cylindrical shaft.

In this embodiment, the idle gear 2a which is smaller than the first planet gear 2 is formed on one side of the first planet gear 2, and the idle gear 2a is geared with the first ring gear 3. The reason is to control a deceleration ratio into a desirable ratio.

In addition, the number of teeth of the first planet gear 2 is larger than the number of teeth of the second planet gear 4, and the two output shafts have the same rotational speed.

In a case that the first output shaft 9 is different in rotational speed from the second output shaft 10, the number of teeth of the first planet gear 2 and the number of teeth of the second planet gear 4 are controlled at a proper ratio so that the second output shaft 10 is slower or faster in the rotational speed than the first output shaft 9.

Moreover, if the first ring gear 3 is large-sized, the idle gear 2a is not formed on one side of the first planet gear 2, but the first planet gear 2 is directly geared with the first ring gear 3.

Finally, because the driving force transferred to one input shaft is outputted to the two output shafts and the two output shafts are rotated in opposing directions to each other, the biaxial rotation type reducer can make a progress direction of a ship or a boat constant in a case that the biaxial rotation type reducer is used in the ship or the boat which generates propulsion by rotating a propeller, increase grinding speed of food in a case that it is used in a mixer, and enhance purification efficiency in a case that it is used in a water purifying apparatus.

Explanation of essential reference numerals in drawings

| | | |
|---|---|---|
| 1: sun gear | 1a: first gear | 1b: second gear |

| | |
|---|---|
| 2: first planet gear | 2a: idle gear |
| 3: first ring gear | 4: second planet gear |
| 5: second ring gear | 6: input carrier |
| 7: center carrier | 8: output carrier |
| 9: first output shaft | 10: second output shaft |

| | |
|---|---|
| 11: pin | 12-21: bearing |

| | |
|---|---|
| 22: fixing bolt | 23: fixing bolt |

1. A biaxial rotation type reducer comprising:
a sun gear (1) to which a driving force of a driving shaft is inputted;
a first planet gear (2) which is formed on one side of the sun gear (1);
an idle gear (2a) which is formed on one side of the first planet gear (2);
a first ring gear (3) which is formed on the outside of the idle gear (2a) and geared with the idle gear (2a);
an input carrier (6), a center carrier (7) and an output carrier (8) which are rotated together by rotation of the first planet gear (2);
a first output shaft (9) which is fixed and combined to the output carrier (8);
a second planet gear (4) which is formed on one side of the first planet gear (2) and in which interference of rotation is minimized by a bearing (19);
a second ring gear (5) which is formed on the outside of the second planet gear (4) and geared with the second planet gear (4); and
a second output shaft (10) which is fixed and combined with the second ring gear (5),
wherein the sun gear (1) has a first gear (1a) and a second gear (1b) which are formed integrally with a shaft in such a way that the first gear (1a) is geared with the first planet gear (2) and the second gear (1b) is geared with the second planet gear (4) to transfer the driving force, and
wherein the first output shaft (9) and the second output shaft (10) receive a rotational force from the sun gear (1) and are rotated in the opposing direction to each other.

2. The biaxial rotation type reducer according to claim 1, wherein the input carrier (6), the center carrier (7) and the output carrier (8) are fixed and combined by a pin (11).

3. The biaxial rotation type reducer according to claim 1, wherein the first planet gear (2) and the second planet gear (4) are separated from each other and the second planet gear (4) is penetrated and combined by the pin (11).
